(19) United States
(12) Patent Application Publication
(10) Pub. No.: US 2022/0105736 A1
(43) Pub. Date: Apr. 7, 2022

(54) ADJUSTING GAP BETWEEN PRINT MEDIA

(71) Applicant: Hewlett-Packard Development Company, L.P., Spring, TX (US)

(72) Inventors: Wei Lit Teoh, Singapore (SG); Yi Xiong Anselm Lim, Singapore (SG)

(73) Assignee: Hewlett-Packard Development Company, L.P., Spring, TX (US)

(21) Appl. No.: 17/426,272

(22) PCT Filed: Mar. 22, 2019
(86) PCT No.: PCT/US2019/023566

§ 371 Date: Jul. 28, 2021

(51) Int. Cl. B41J 11/00

(52) U.S. Cl. CPC B41J 11/0095

(57) ABSTRACT

The present subject matter relates to examples of adjusting the gaps between a first print medium and a second print medium. In one example, the first print medium may be picked by a pick-up roller from an input tray and may be conveyed to towards a transfer roller along a travel path. Further, according to the example, a homing position of the first print medium along the travel path may be determined. Once the homing position is determined, a second print medium may be picked by the pick-up roller. Further, a gap between a leading edge of the second print medium and a trailing edge of the first medium may be adjusted by regulating a rotational speed of the pick-up roller based on a rotational speed of the transfer roller.

### BACKGROUND

Imaging devices, such as a printer may be employed to print content on a variety of print media. The imaging devices may include additional functions, such as scanning, and/or photocopying of the print media. Generally, the imaging device includes a print mechanism that prints the content on the print media, a compartment that stores the print media for scanning, and a feeding mechanism that feeds the print media from the compartment along a travel path to the print mechanism where the print media is printed. The travel path is a path that the print medium traverse from the compartment to the print mechanism.

### BRIEF DESCRIPTION OF DRAWINGS

The detailed description is provided with reference to the accompanying figures, wherein:

FIG. 1 illustrates an example of a network environment employing an imaging device, according to an example;

FIG. 2 illustrates the imaging device for forming the markings on the print media, according to an example;

FIG. 3 illustrates a detailed schematic of the imaging device for forming the markings on the print media, according to an example;

FIG. 4 illustrates a side view of the imaging device depicting pickup of a first print medium by a pick-up roller, according to an example;

FIG. 5 illustrates a side view of the imaging device depicting detection of a leading edge of the first print medium by a sensor, according to an example;

FIG. 6 illustrates a side view of the imaging device depicting the first print medium at the homing position at the transfer roller, according to an example;

FIG. 7 illustrates a side view of the imaging device depicting the first print medium at the homing position at the deskew mechanism, according to an example;

FIG. 8 illustrates a side view of the imaging device depicting movement of the second print medium by the pick-up roller towards the transfer roller, according to an example;

FIG. 9 illustrates a side view of the imaging device depicting adjustment of a gap between the first print medium and the second print medium, according to an example;

FIG. 10 illustrates a method of adjusting the gap, according to an example;

FIGS. 11A and 11B illustrate a detailed method for adjusting the gap, according to an example; and

FIG. 12 illustrates a non-transitory computer readable medium, according to an example.

### DETAILED DESCRIPTION

A feeding mechanism of an imaging device may include a roller that picks the print medium and another roller that feeds the picked print medium to the print mechanism. The feeding mechanism may implement a technique known as tailgating to maintain a predetermined gap between two consecutive print media to ensure that a throughput of the imaging device is maintained while ensuring that there is no overlap of the print media sheet that can cause jamming of the imaging device. Further, in order to maintain the gap between two consecutive print media, the feeding mechanism may employ various techniques. For example, in one technique, the imaging device may include different types of sensors with various capabilities including the ability to detect movement of the print medium inside the imaging device. In another technique, as an example, the feeding mechanism may include a set of rollers which may rotate at a fixed speed to pick the print media at predetermined time intervals. However, some imaging devices may be designed to vary a speed at which the print medium is fed to the printing mechanism, for instance, the print medium may not move at a constant speed along the travel path. Accordingly, the gap between the consecutive print media may vary and the latter type of feeding mechanisms discussed above may be unable to cater to such an operation of the imaging device.

On the other hand, in the feeding mechanisms that uses sensors, an array of sensors may be used for detecting the movement of the print medium moving towards the print mechanism. Generally, the feeding mechanism may initiate pick-up of the next print medium once the array of sensors indicates that the print medium has passed through. In other words, the array of sensors can track exact movements of the print medium and, accordingly, provide for a well-regulated movement of the print medium along the travel path. While such sensor-based mechanisms may cater to the varying speed of the print media, such mechanisms may be complex in construction and operation, owing to the use of array of sensors and their data. As a result, the imaging devices using the array of sensors may be expensive to manufacture and operate. Moreover, the use of array of sensors may make the imaging device prone to failure owing to the complexity. For instance, any fault in one sensor from the array of sensor may cause failure of the entire feeding mechanism.

Examples of techniques of adjusting a gap between consecutive print media are described. According to an aspect, the present subject matter involves use of a reference position, referred as to a homing position, along a travel path and tracking movement of print media along the travel path for adjusting the gap between the consecutive print media. Accordingly, as an example, the movement of a print medium may be tracked using a low-cost, low capability sensor which can identify passage of an edge of the print medium. Such a detection by the sensor combined with tracking of an operation of the imaging device may be used, in said example, to detect whether the print medium has reached the homing position, which acts as a reference to pick the next print medium. Thereafter, the gap between the consecutive print media can be adjusted, and then, the movement of the two consecutive print media can be so controlled to ensure that the gap between them is maintained. For example, a rate of movement of the picked print medium is regulated based on a rate of movement of the print medium preceding it for adjusting the gap as well as maintaining the gap.

According to an example, a print medium is picked up by a pick-up roller of the imaging device while a transfer roller of the imaging device feeds a preceding print medium to a print mechanism of the imaging device. Motions of the pick-up roller and the transfer roller may be desynchronized to allow pick-up and also to adjust a gap between the picked print medium and the preceding print medium. Further, once the gap is adjusted, motions of the pick-up roller and the transfer roller may be synchronized so that the picked print medium may be moved by the pick-up roller and the transfer roller towards the print mechanism until the arrival of the picked print medium at a homing position. In one example, arrival at the homing position is determined based on a length of travel path traversed by the picked print medium. Further, the length of travel path traversed by the picked print medium may be determined by detecting a leading edge of the picked print medium as the print medium traverse the travel path and the motion exhibited by the transfer roller thereafter. As mentioned previously, the leading edge may be detected using the sensor.

Upon arrival of the picked print medium at the homing position, motions of the pick-up roller and the transfer roller may be desynchronized again, and a subsequent print medium may be picked by the pick-up roller. Simultaneously, the transfer roller may feed the print medium towards the print medium. Moreover, the motion of the pick-up roller may be varied to adjust a gap between the print medium being fed towards the print mechanism and the subsequent print medium, for example, based on a motion of the transfer roller for moving the print medium with respect to the print mechanism for creating markings on the print medium. In one example, creating the marking can be injecting ink on the print medium to create the markings. Further, as explained above, once the gap has been adjusted, the gap is then maintained by synchronizing the motion of the pick-up roller and the transfer roller again.

In one example, as part of adjusting the gap, the gap between the consecutive print media can be reduced. In said example, the rotational speed of the pick-up roller may be increased and, accordingly, a time between an end of the printing operation on the preceding print medium and beginning of a printing operation on the subsequent print medium can be low. In another example, the gap between the consecutive print media can be increased, and accordingly, the rotational speed of the pick-up roller may be reduced. Such a gap adjustment can be done, for example, to prevent overlapping of print media or for preventing jamming.

Further, since the imaging devices based on the present subject matter uses a low-cost sensor to manage the gaps, the manufacturing cost, operational cost, and maintenance cost associated with the imaging device is low. Moreover, the imaging device of the present subject matter does not include complex components thereby making the imaging device less prone to failures, owing to fewer parts.

In the illustrated example, the use of the terms “preceding print medium” and the “subsequent print medium” does not indicate a predefined order. Further, the term “preceding” is does not indicate a first page of a printing operation. Instead, in this context, the terms “preceding print medium” and “subsequent print medium” merely indicate a consecutive relationship between individual media.

The above aspects are further described in conjunction with the figures, and in associated description below. It should be noted that the description and figures merely illustrate principles of the present subject matter. Therefore, various implementations that encompass the principles of the present subject matter, although not explicitly described or shown herein, may be devised from the description and are included within its scope. Additionally, the word “coupled” is used throughout for clarity of the description and can include either a direct connection or an indirect connection.

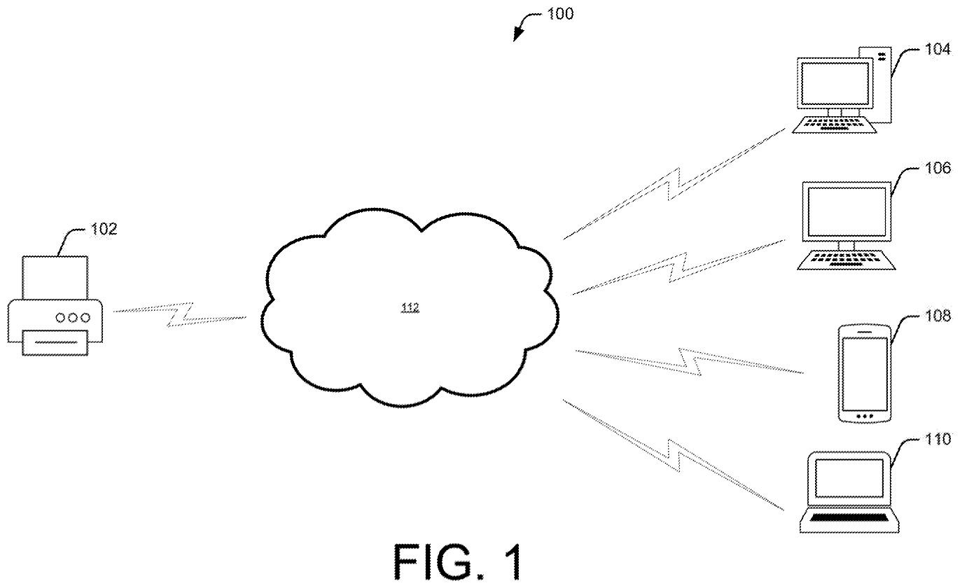

FIG. 1 illustrates a network environment 100 that may include an imaging device 102 for forming the markings on the print media, according to an example. the imaging device 102 can be, but not limited to, a printing device, a photo copier, and a scanner. Further, the imaging device 102 can be an inkjet printer. In another example, imaging device 102 may also include a scanning unit for scanning the print media, in case the imaging device 102 is a scanner or a photocopier. In an example, the process of forming the marking may include injecting ink on the print medium on the print medium. The network environment 100 may also include a plurality of user devices 104, 106, 108, and 110 that may communicate with the imaging device 102. For instance, the user devices 104, 106, 108, and 110 can be a mobile phone, a laptop, a handheld PC, or the like. According to an example, the network environment 100 may include imaging device 102 that may be connected to the user devices 104, 106, 108, and 110 through a communication network 112. In one example, the communication network 112 may be a wireless network, a wired network, or a combination thereof.

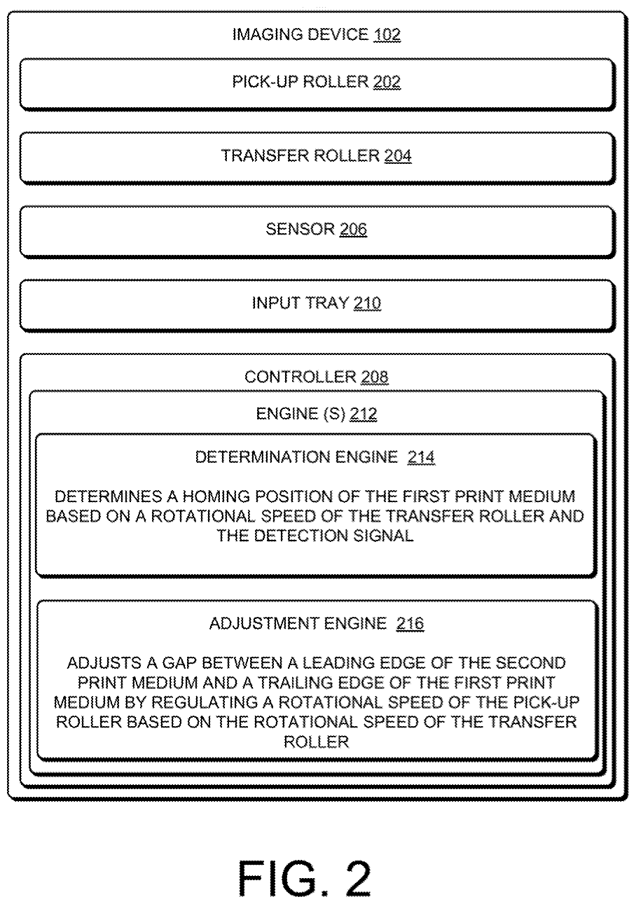

The imaging device 102 based on the present subject matter may receive instructions from one of the user devices 104, 106, 108, and 110 over the communication network 112 to print content on print media stored in the imaging device 102. In one example, the instructions may include parameters regarding the print media, for instance, the size, on which the markings are to be formed. In addition, the instructions may include margins for the print media. Upon receipt of the instructions, the imaging device 102 may commence formation of markings on a print medium. In one example, formation of markings may include injecting ink on the print medium. In the illustrated example, the imaging device 102 may use of a reference position, referred as to a homing position, along a travel path and tracking movement of print media along the travel path for adjusting the gap between the consecutive print media. Further, the movement of a print medium may be tracked using a sensor which can identify passage of an edge of the print medium. Further, detection of the arrival of the print medium at the homing position may act as a reference to pick the next print medium. Thereafter, the gap between the consecutive print media can be adjusted and may be maintained. For example, a rate of movement of the picked print medium is regulated based on a rate of movement of the print medium preceding it for adjusting the gap as well as maintaining the gap. The construction and operation of the imaging device 102 is explained with respect to FIG. 2 to FIG. 9.

FIG. 2 illustrates an imaging device 102, according to an example. The imaging device 102 may include a pick-up roller 202, a transfer roller 204, a sensor 206, and a controller 208. The controller 208 may further include engines 212. The engines 212 may be a combination of hardware and programming (for example, programmable instructions) to use functionalities of the engines 212. Engines 212 are not intended to encompass software per se. For example, the programming for the engines 212 may be processor executable instructions stored on a non-transitory machine-readable storage medium and the hardware for the engines 212 may include a processing resource (for example, processors), to execute such instructions. In the present examples, the machine-readable storage medium stores instructions that, when executed by the processing resource, deploy engines 212. In such examples, imaging device 102 may include the machine-readable storage medium storing the instructions and the processing resource to execute the instructions, or the machine-readable storage medium may be separate but accessible to the imaging device 102 and the processing resource. In other examples, engines 212 may be deployed using electronic circuitry (e.g., field-programmable gate array (FPGA), application-specific integrated circuits (ASICs), etc.). According to an example, the controller 208 may include a determination engine 214 and an adjustment engine 216.

According to an example, the pick-up roller 202 may pick the print media stored in an input tray 210. Further, the transfer roller 204 may receive the print media from the pick-up roller 202 and move the picked print media along a travel path. The travel path may be a path that the print media traverse from the input tray to a print mechanism. Furthermore, the sensor 206 may detect an edge, for instance, a leading edge of the print medium as the print medium travels past the sensor 206. The controller 208 may obtain information from the sensor 206 and use it regulate the operation of the pick-up roller 202 and the transfer roller 204 to adjust a gap between consecutive print media, such as a first medium and a second medium from the print media. In the illustrated example, the use of the term “first print medium” and the “second print medium” does not indicate a predefined order. Further, the term “first” is does not indicate a first page of a printing operation. Instead, in this context, the terms “first print medium” and “second print medium” merely indicate a consecutive relationship between individual media.

For instance, upon detecting the passage of the leading edge of the first print medium, the sensor 206 may generate a detection signal. In turn, the controller 208 may receive the detection signal which can trigger the controller 208 to determine if the first print medium has arrived at the homing position. Based on the determination, the controller 208 may regulate the rotational speeds of the pick-up roller 202 and the transfer roller 204, to initiate the pick-up of the second print medium by the pick-up roller 202 as well as to adjust the gap between the first and the second print medium. For instance, the controller 208 may regulate the rotational speeds of the pick-up roller 202 and the transfer roller 204 in order to adjust a gap between the first print medium and the second medium. In one example, a de-skew operation on the print medium may be performed while at the homing position. In another example, the formation of the markings on the print medium by the print mechanism commence at the homing position.

In operation of the controller 208, the determination engine 214 can determine when the first print medium, travelling on the travel path, arrives at the homing position. As mentioned above, such a determination can be initiated in response to the sensor 206 detecting the passage of the leading edge of the first print medium, such as upon receipt of the detection signal by the determination engine 214. Reception of the detection signal may be used, for instance, by the controller 208 to begin tracking a degree of movement of the medium subsequent to the position of the medium at which the edge is detected. Thereafter, the determination engine 214 may measure a degree of rotation of the transfer roller 204 to determine whether the first print medium has arrived at the homing position. Further, the adjustment engine 216 that may vary a gap between the second print medium and the first print medium after the first print medium has arrived at the homing position. For instance, the adjustment engine 216 may adjust a gap between a leading edge of the second print medium and a trailing edge of the first print medium, for instance, by regulating a rotational speed of the pick-up roller 202, with due consideration to the rotational speed of the transfer roller 204. Once the gap is adjusted, the adjustment engine 216 may maintain a constant gap between the first and the second print media.

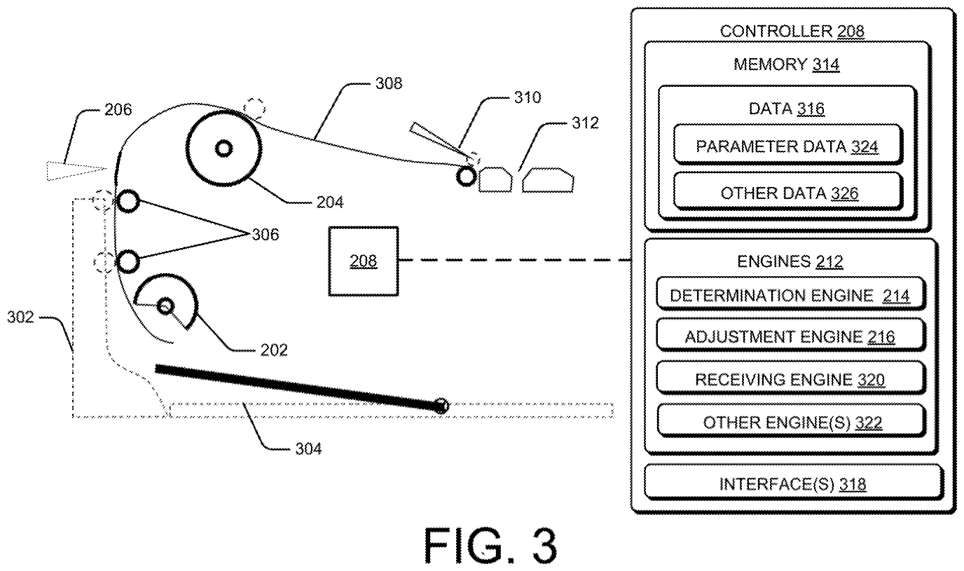

FIG. 3 illustrates a cross sectional view of the imaging device 102, according to an example. In addition to the components discussed in FIG. 2, the imaging device 102 may include a deskew mechanism 310, a print area 312, and a frame 302 to support different components of the imaging device 102 mounted thereon. The frame 302 may be used to mount the pick-up roller 202, the transfer roller 204, the sensor 206, various other components of the imaging device 102 as explained previously. Further, the imaging device 102 may include an input tray 304 that may store the print media. Although the illustrated example shows a single input tray, the imaging device 102 may also include multiple input trays to store print media of different sizes.

As mentioned above, in operation of the imaging device 102, the controller 208 may obtain information from the sensor 206 and use it to regulate the operation of the pick-up roller 202 and the transfer roller 204 to adjust a gap between consecutive print media, such as a first medium and a second medium from the print media. In addition, the controller 208 can control the pick-up roller 202 to pick the print media stored in an input tray 210 and move the print media to the transfer roller 204 and control the transfer roller 204 to move the picked print media along the travel path towards the print mechanism (not shown). The transfer roller 204, for instance, may be installed downstream with respect to the pick-up roller 202 along the travel path and the imaging device 102 may include a plurality of idle rollers 306 placed along the travel path to facilitate movement of the print medium 308, along the travel path.

For instance, the pick-up roller 202 may be in contact with a stack of print media in the input tray 304 and may pick up the print medium placed at the top of the stack. Furthermore, the pick-up roller 202 may pick up the print medium upon receipt of a command by the controller 208 from a user device for forming markings on the print media. Accordingly, the controller 208 can regulate the pick-up roller 202 to move the print medium to the transfer roller 204 along the travel path. In an example, the pick-up roller 202 may be coupled to a variable-speed motor which is controlled by the controller 208 to move the print media along the travel path and to also regulate the motion of the print media along the travel path. Similarly, the transfer roller 204 may also be coupled to a variable-speed motor controlled by the controller 208 to move the print medium to the print mechanism and then move the print medium with respect to the print mechanism based on the markings to be formed on the print medium. For example, the variable-speed motor can be any one of a servo motor and a stepper motor. Further, the pick-up roller 202 and the transfer roller 204 may be provided with similar or different kinds of variable-speed motors.

Further, the sensor 206 may be installed along the travel path, for instance, at any position along the travel path, such that a distance between the sensor 206 and the transfer roller 204 is known. In one example, the imaging device 102 may be installed proximate to the pick-up roller 202. In another example, the sensor 206 may be installed proximate to the transfer roller 204. The sensor 206 may be, as an example, an optical sensor and/or an infrared sensor. As mentioned previously, the sensor 206 may detect the leading edge or a trailing edge of the print medium as the print medium travels past the sensor 206, during operation of the imaging device 102. Accordingly, the sensor 206 may generate the detection signal upon detecting the edge and pass the detection signal to the controller 208 which may be triggered to determine when the first print medium arrives at the homing position.

The controller 208, in addition to the components discussed previously, includes a memory 314 having data 316, and interface(s) 318. Further, the engines 212, among other capabilities, may fetch and execute computer-readable instructions stored in the memory 314. The memory 314, communicatively coupled to the engines 212, may include a non-transitory computer-readable medium including, for example, volatile memory, such as Static Random-Access Memory (SRAM) and Dynamic Random-Access Memory (DRAM), and/or non-volatile memory, such as Read-Only-Memory (ROM), erasable programmable ROM, flash memories, hard disks, optical disks, and magnetic tapes. Further, the data 316 may include parameter data 324 and other data 326. The other data 326 may include data generated and saved by the engines 212 to provide various functionalities to the imaging device 102.

Further, the engines 212 may additionally include a receiving engine 320 and other engine(s) 322. In one example, the receiving engine 320 may receive the detection signal and instructions to perform a printing operation. The other engine(s) 322 may provide functionalities that supplement applications or functions performed by the imaging device 102. Further, the adjustment engine 216 may regulate rotational speeds of the transfer roller 204 and the pick-up roller 202. For instance, the adjustment engine 216 may regulate the rotational speed of the transfer roller 204 based on printing parameters, such as a size of print media, and margins for the first print medium to form the markings. Accordingly, the rotational speed of the transfer roller 204 may be regulated.

As mentioned previously, the determination engine 214 may determine when the first print medium, travelling on the travel path, arrives at the homing position. The determination, by determination engine 214, may begin in response to reception of the detection signal from the sensor 206. Accordingly, after the leading edge of the first print medium has passed the sensor 206, from that point in time, the determination engine 214 can measure a degree of rotation of the transfer roller 204 to determine whether the first print medium has arrived at the homing position. In the meantime, after the detection signal has been received, the determination engine 214 may synchronize the motion of the pick-up roller 202 and the transfer roller 204 so as to allow a smooth movement of the first print medium which is achieved by the motion of the pick-up roller 202 and the transfer roller 204. In case where the pick-up roller 202 and the transfer roller 204 are of a same size, the determination engine 214 may match the rotational speeds of both the rollers 202, 204 to synchronize the motions. In another case where the pick-up roller 202 and the transfer roller 204 are of different sizes, the determination engine 214 may regulate the motion of the both the rollers 202, 204 in a way that the speed at which the first print medium moves along both the rollers 202, 204 is the same.

Further, upon determination of the arrival of the first print medium, the determination engine 214 of the controller 208 may desynchronize the motion of the pick-up roller 202 and transfer roller 204. The desynchronization of the motion, in an example, means that the pick-up roller 202 and the transfer roller 204 can exhibit independent motions, for instance, at different speeds. This may allow the pick-up roller 202 and the transfer roller 204 to perform disjunct functions at the same time, in contrast to the conjugated function of smoothly moving the first print medium to the print mechanism, where their motions are synchronized.

Accordingly, upon determining the arrival of the first print medium at the homing position the determination engine 214 may desynchronize the motions of the pick-up roller 202 and the transfer roller 204. For instance, the determination engine 214, after desynchronization, may control the pick-up roller 202 to pick the second print medium 408 from the input tray while at the same time, the transfer roller 204 can move the print medium, for example, based on the print parameters, for forming the markings. As explained above, the motions of the pick-up roller 202 and the transfer roller 204 are independent of each other and are based on the respective operation that they are performing.

Once the second print medium has been picked up, the adjustment engine 216 may then adjust the gap between the first print medium and the second print medium based on the motion of the transfer roller 204. For instance, the adjustment engine 216 control the pick-up roller 202, such that the gap between the consecutive print media can be reduced. In said example, the adjustment engine 216 may control the servo motor of the pick-up roller 202 to increase the rotational speed of the pick-up roller may be increased, such that a time between an end of the printing operation on the preceding print medium and beginning of a printing operation on the subsequent print medium is reduced. In another example, adjustment engine 216 may control the servo motor of the pick-up roller 202 to decrease the rotational speed, such that the gap between the consecutive print media can be increased.

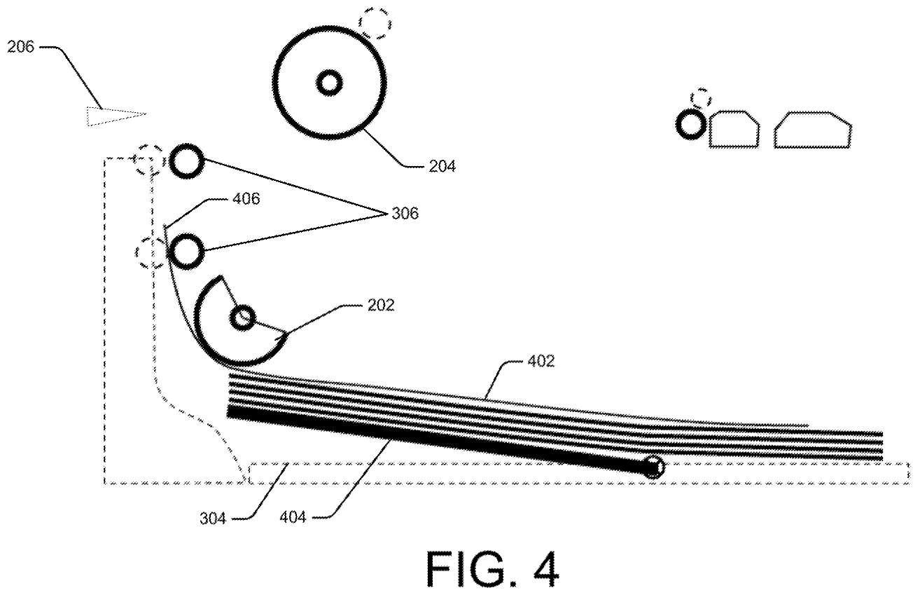

FIG. 4-9 illustrates an operation of the imaging device 102, according to an example. Initially, the receiving engine 320 of the controller 208 may receive instructions to form the markings on a plurality of print media. In one example, the instructions may include the markings to be formed, margins for the print medium, and other settings. Upon receipt of the instructions, the controller 208 may actuate the servo motor of the pick-up roller 202 to pick the first print medium 402 from the input tray 304 as shown in FIG. 4. In the illustrated example, the input tray 304 may include a biasing member 404 that biases the stack of the print media against the pick-up roller 202 such that the print medium on the top is in contact with and picked by the pick-up roller 202. Once the first print medium 402 is picked, the pick-up roller 202 may move the first print medium 402 on the travel path towards the transfer roller 204. In one example, until a leading edge 406 of the first print medium 402 moves past the sensor 206, motion of the transfer roller 204 may de-synchronized with the motion of the pick-up roller 202. As the first print medium 402 moves along the travel path, the leading edge 406 of the first print medium 402 may move past the sensor 206 and accordingly, the sensor 206 detects the leading edge of the first print medium 402 and generates the detection signal. Thereafter, the sensor 206 relays the detection signal to the determination engine 214.

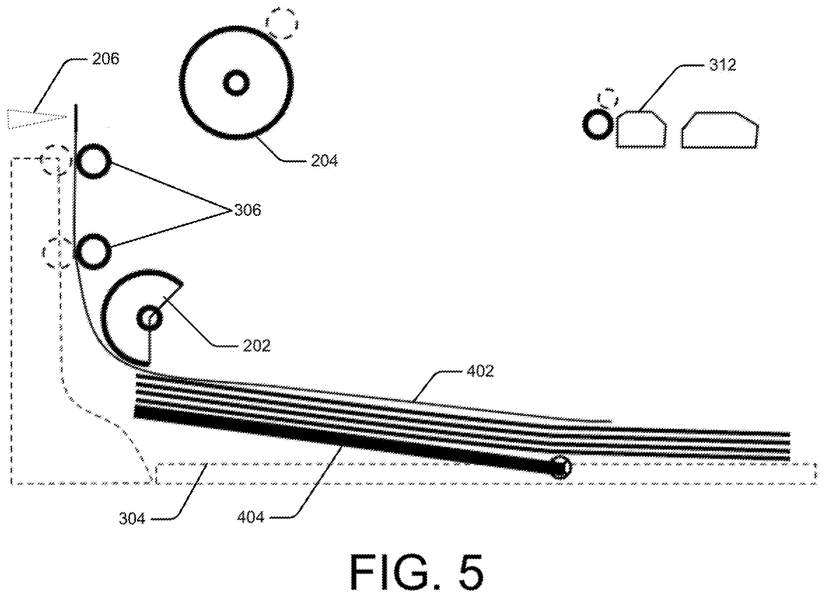

Upon receipt of the detection signal, the determination engine 214 synchronizes motion of the pick-up roller 202 and the transfer roller 204, such that the rates at which the first print medium 402 is conveyed by the pick-up roller 202 and the transfer roller 204 are same. Meanwhile, the pick-up roller 202 and the idle rollers 306 moves the first print medium 402 towards the transfer roller 204 as shown in FIG. 5. As mentioned before, motions of the pick-up roller 202 and the transfer roller 204 remain synchronized until the first print medium 402 reaches the homing position.

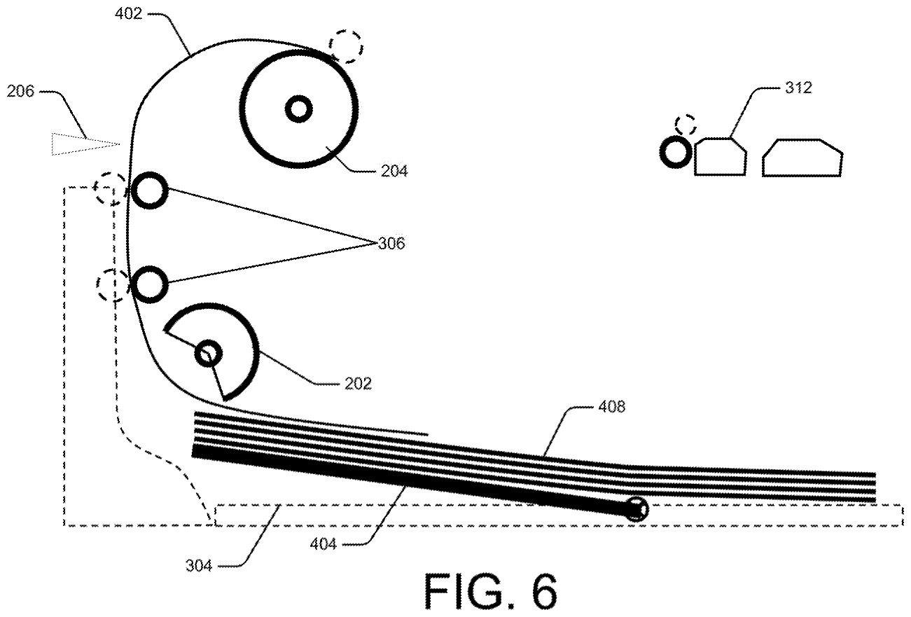

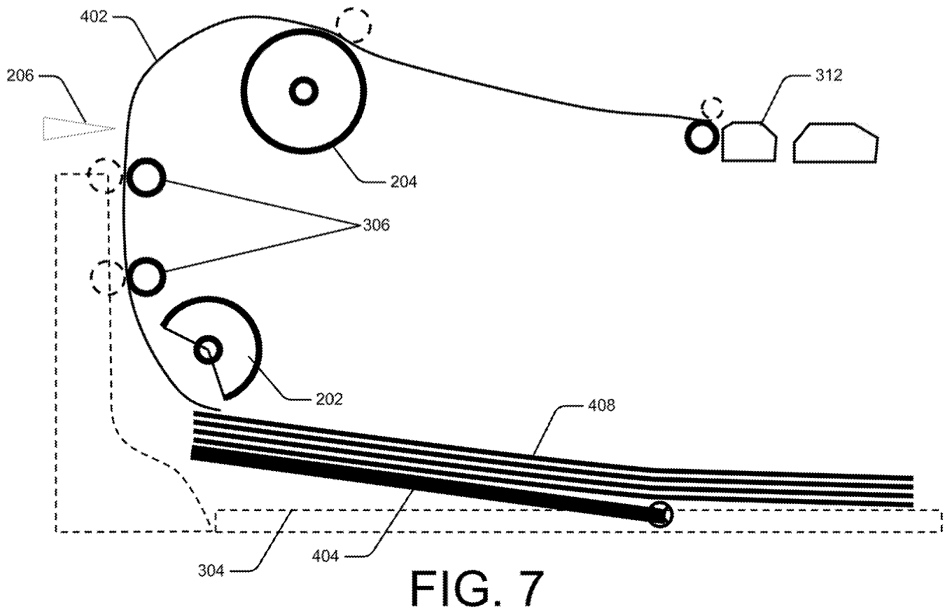

According to an example, the determination engine 214 may determine when the first print medium 402 reaches the homing position. Knowledge of the homing position may be useful for a number of different purposes. For instance, the homing position can be a position where the leading edge of the first print medium 402 reaches the transfer roller 204, as shown in FIG. 6. In another instance, the homing position can be a position where the de-skew operation is performed, as shown in FIG. 7. In yet another example, the homing position can be a position where the print mechanism begins formation of the markings. The homing position of the imaging device 102 may be peculiar to each imaging device 102 and the controller 208 for that imaging device 102 may be configured based on the homing position for that imaging device 102. In the illustrated example, upon receipt of the detection signal, the determination engine 214 may start measuring a degree of rotation of the transfer roller 204.

In the illustrated example, the determination engine 214 may include information, such as a Length the Travel Path between the sensor and the homing position. Further, the Length the Travel Path may be pre-fed based on a design of the imaging device 102. As mentioned before, the determination engine 214 may determine arrival of the first print medium 402 at the homing position using the degree of rotation of the transfer roller 204 and the length of the path described by the first print medium. For instance, the determination engine 214 may determine a time at which the first print medium 402 arrives at the homing position after traversing the Length the Travel Path between the sensor 206 and the homing position based on the degree of rotation of the transfer roller 204.

In another example, the determination engine may determine the Length of the Travel Path based on a variety of parameters stored as parameter data 324 and using the formula:

Length of Travel Path=(L±B)−A−C±D±E

In yet example, the determination engine 214 may be reconfigured based on the parameters ‘D’ and ‘E’ and design related parameter ‘L’, ‘A’, and ‘C’ of the imaging device 102, if the Length of the Travel Path is known using the formula:

D+E=Length of Travel Path+(A+B+C)+L)

For instance, one of the parameters can be an offset ‘A’ between a position where printing operation is performed on the first print medium 402 and a position where printing operation is performed on the second print medium 408 owing to the difference in the margins for the first print medium 402 and the second print medium 408. Another parameter can be a maximum supportable length ‘L’ of the print medium and a difference ‘t B’ between the maximum supportable length and a prestored media length associated with the imaging device 102. Yet another parameter can be slippage ‘C’ of the print medium when the print medium is picked by the pick-up roller 202. According to an example, one parameter can be a predefined delay ‘D’ that the controller 208 may be configured to induce and another parameter can be a known reference point ‘±E’ along the length of the travel path. Further, the parameters ‘L’, ‘A’, ‘C’, and ‘D’ may be based on a design of the imaging device 102 while the parameters ‘D’ and ‘E’ may be varied.

According to an example, once the determination engine 214 determines the homing position, the determination engine 214 may desynchronize the motion of the pick-up roller 202 and the transfer roller 204, such that the rotational speed of the pick-up roller 202 and the transfer roller 204 may be independent of each other. Thereafter, the determination engine 214 may actuate the servo motor of the pick-up roller 202 to initiate the pick-up of the second print medium 408 from the input tray. Simultaneously, the determination engine 214 may control the servo motor of the transfer roller 204 to move the first print medium 402 towards the print area 312.

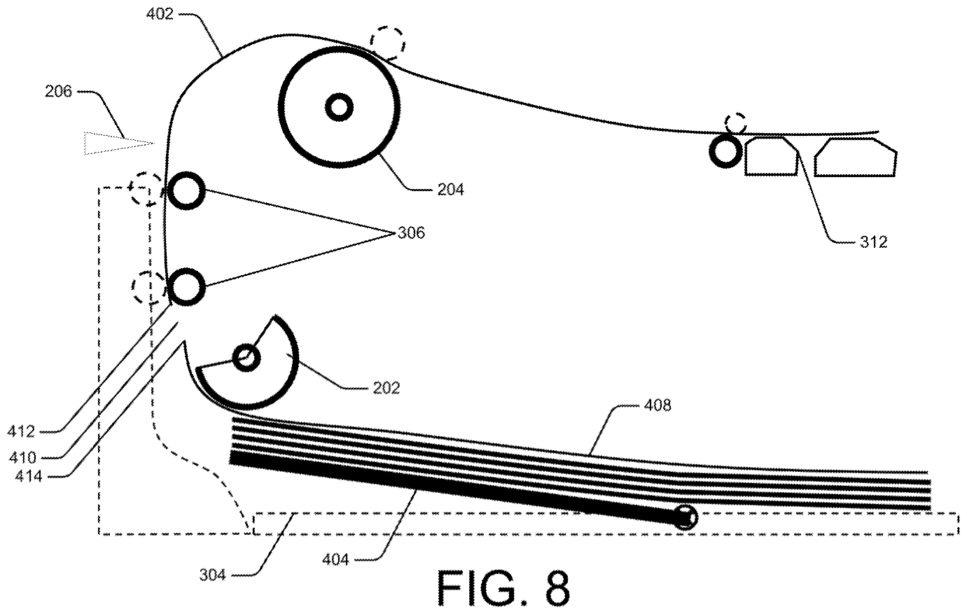

Further, the adjustment engine 216 may regulates the servo motor of the transfer roller 204 for regulating the movement of the first print medium 402 based on the received instructions. Simultaneously, the adjustment engine 216 may measure the rotational speed of the transfer roller 204 to synchronize the rotational speed of the pick-up roller 202 with the transfer roller 204 to maintain the predetermined gap 410 between a trailing edge 412 first print medium 402 and a leading edge 414 of the second print medium 408 as shown in FIG. 8.

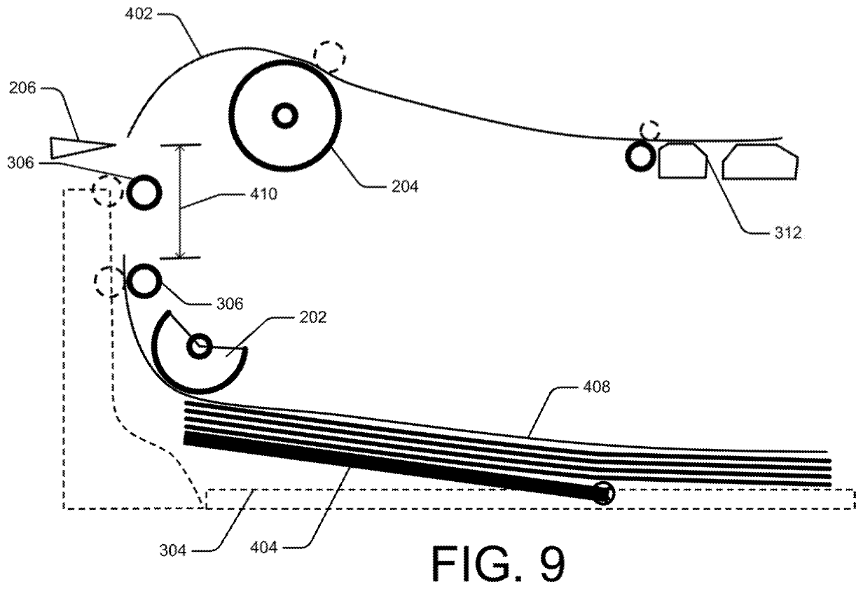

In one example, the adjustment engine 216 may vary the gap 410, for instance, reduces the gap 410. In such a case, the adjustment engine 216 may operate the servo motor of the pick-up roller 202 to increase the rotational speed of the pick-up roller 202 thereby reducing the gap 410 as shown in FIG. 8. In another example, the adjustment engine 216 may increase the gap 410 in case the adjustment engine 216 that the gap 410 is small enough to cause the paper jam as shown in FIG. 9.

Further, as the second print medium 408 moves along the travel path, the second print medium 408 moves past the sensor 206. As the second print medium 408 moves past the sensor 206, the sensor 206 detects the leading edge 414 of the second print medium 408. Once the leading edge 414 is detected, the controller 208 may operate in a way as explained before. Further, the same operation may be performed until the printing operation is completed.

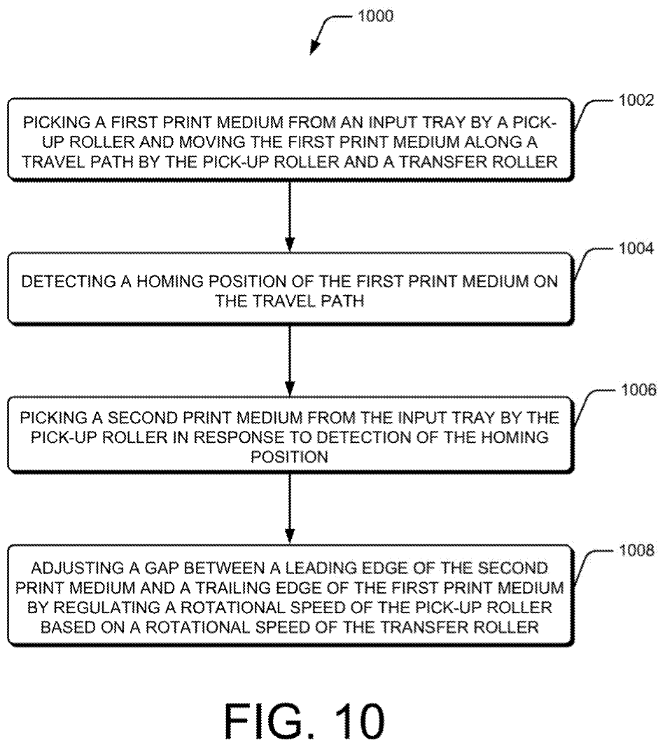

FIG. 10 illustrates a method 1000 for adjusting a gap between two consecutive print media according to an example of the present subject matter. The method(s) may be described in the general context of computer executable instructions. Generally, computer executable instructions can include routines, programs, objects, components, data structures, procedures, engines, functions, etc., that perform particular functions or employ particular abstract data types. The method may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to employ the method 1000, or an alternative method. Additionally, individual blocks may be deleted from the methods without departing from the spirit and scope of the subject matter described herein. Furthermore, the methods 1000 can be employed in any suitable hardware, software, firmware, or combination thereof. The method 1000 is explained with reference to the imaging device 102, however, the methods can be employed in other systems as well.

Referring to FIG. 10, at block 1002, the first print medium 402 may be picked by the pick-up roller 202 from the input tray 304. In addition, the first print medium 402 may move along the travel path by the pick-up roller 202 and the transfer roller 204 in a manner explained above.

Further, at block 1004, a position of the first print medium with respect to a homing position on the travel path may be detected. In one example, the determination engine 214 may determine the position of the first print medium by tracking the movement of the first print medium along the travel path. In addition, the determination engine 214 may also determine the homing position as explained above.

At block 1006, the second print medium 408 may be picked by the pick-up roller 202, in response of detecting that the position of the first print medium 402 is the homing position.

Finally, at block 1008, the gap 410 between the trailing edge 412 of the first print medium 402 and the leading edge 414 of the second print medium 408 by regulating the rotational speed of the pick-up roller 202 based on the rotational speed of the transfer roller 204.

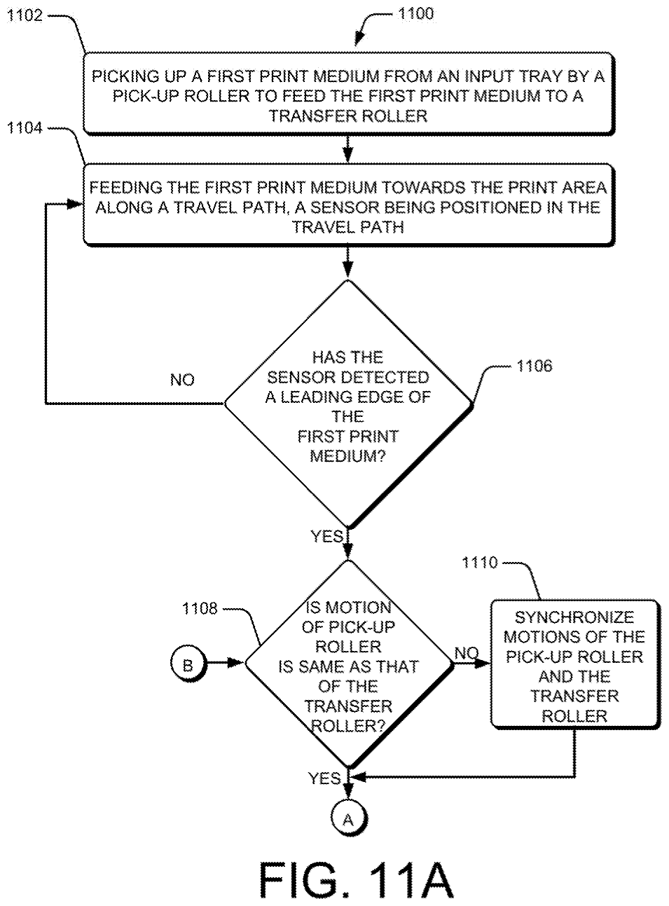

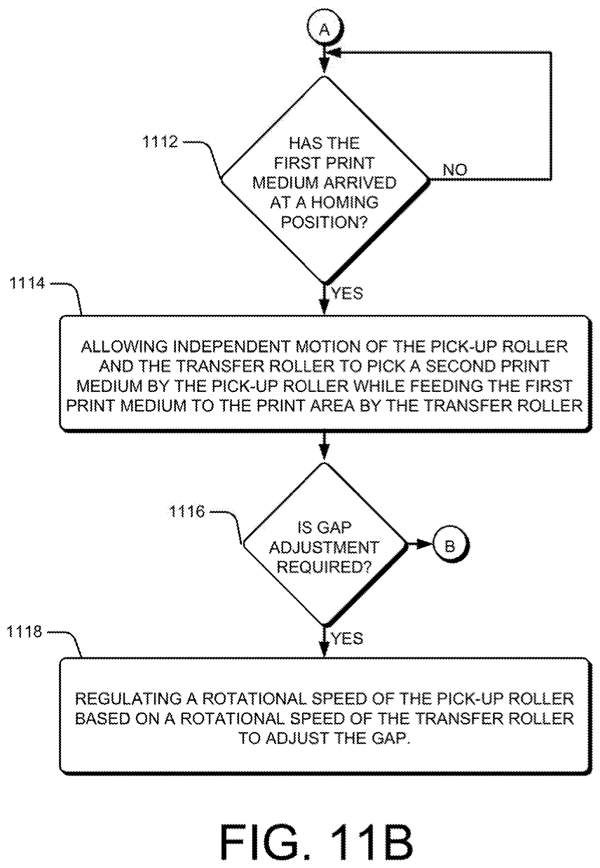

FIG. 11 illustrates a detailed method 1100 for adjusting a gap between two consecutive print media according to an example of the present subject matter. Like the method 1000, the method 1100 may be described in the general context of computer executable instructions. Generally, computer executable instructions can include routines, programs, objects, components, data structures, procedures, engines, functions, etc., that perform particular functions or employ particular abstract data types. The method may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to employ the method 1100, or an alternative method. Additionally, individual blocks may be deleted from the methods without departing from the spirit and scope of the subject matter described herein. Furthermore, the methods 1100 can be employed in any suitable hardware, software, firmware, or combination thereof. The method 1100 is explained with reference to the imaging device 102, however, the methods can be employed in other systems as well.

Initially, at block 1102, the pick-up roller 202 may pick the first print medium 402 to move the first print medium 402 (shown in FIG. 4) to the transfer roller 204. Further, at block 1104, the first print medium 402 is moved along the travel path and fed towards a print area. As explained previously, the sensor 206 may be positioned along the travel path to detect a leading edge of the first print medium 402. At block 1106, the leading edge 406 of the first print medium 402 is detected. In the leading edge is not detect, the method 1100 moves back to block 1104. Alternatively, the method 1100 moves to block 1108 where it is determined that the motion of the pick-up roller 202 is same with the motion of the transfer roller 204. In case the motion of the pick-up roller 202 is not same as that of the transfer roller 204, then the motion of the pick-up roller 202 is synchronized with the transfer roller 204 at block 1110 and the method moves to the block 1112. In case the motion of the pick-up roller 202 is same as that of the transfer roller 204, the method 1100 moves directly to block 1112.

At block 1112, the determination engine 214 check if the first print medium has arrived at the homing position. In case the first print medium 402 has not arrived at the homing position, the method 1100 moves to block 1110. Further, in case the determination engine 214 determines that the first print medium 402 has arrived at the homing position, the method 1100 moves to block 1114. A manner by which the determination engine 214 determines when the first print medium 402 arrives at the homing position has already been explained before with respect FIG. 4-9. At block 1114, the determination engine 214 desynchronize motions of the pick-up roller 202 and the transfer roller 204 to allow independent motion of the pick-up roller 202 and the transfer roller 204. Thereafter, the determination engine 214 may initiate the pickup of the second print medium 408 (shown in FIG. 6). Simultaneously, the determination engine 214 actuates the transfer roller 204 to feed the first print medium 402 to the print area. Further, at block 1116, the adjustment engine 216 may check if any adjustment in the gap between the trailing edge 412 of the first print medium 402 and the leading edge 414 of the second print medium 408 is needed. In case the adjustment of gap is not needed, the method moves to block 1118. On the other hand, in case the adjustment of gap is needed, the rotational speed of the pick-up roller is regulated by the adjustment engine 216 based on the rotational speed of the transfer roller 204 to adjust the gap.

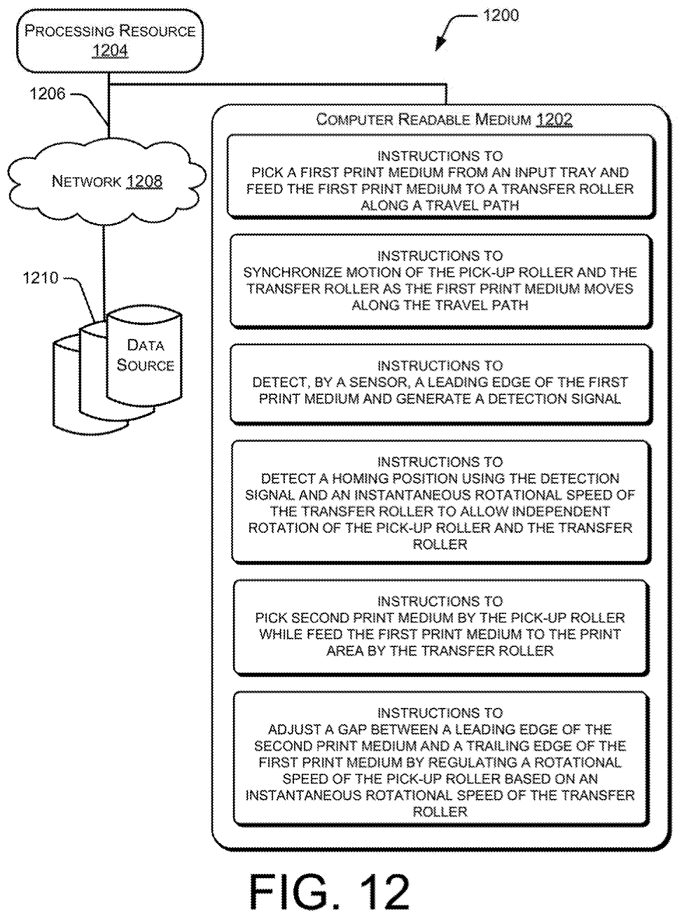

FIG. 12 illustrates an example network environment 1200 using a non-transitory computer readable medium 1202 to assign the mobility factor, according to an example of the present subject matter. The network environment 1200 may be a public networking environment or a private networking environment. In one example, the network environment 1200 includes a processing resource 1204 communicatively coupled to the non-transitory computer readable medium 1202 through a communication link 1206.

For example, the processing resource 1204 may be a processor of a computing system, such as the imaging device 102. The non-transitory computer readable medium 1202 may be, for example, an internal memory device or an external memory device. In one example, the communication link 1206 may be a direct communication link, such as one formed through a memory read/write interface. In another example, the communication link 1206 may be an indirect communication link, such as one formed through a network interface. In such a case, the processing resource 1204 may access the non-transitory computer readable medium 1202 through a network 1208. The network 1208 may be a single network or a combination of multiple networks and may use a variety of communication protocols.

The processing resource 1204 and the non-transitory computer readable medium 1202 may also be communicatively coupled to data sources 1210 over the network 1208. The data sources 1210 may include, for example, databases and computing devices. The data sources 1210 may be used by the database administrators and other users to communicate with the processing resource 1204.

In one example, the non-transitory computer readable medium 1202 includes a set of computer readable and executable instructions, such as the engines 212. The set of computer readable instructions, referred to as instructions hereinafter, may be accessed by the processing resource 1204 through the communication link 1206 and subsequently executed to perform acts for network service insertion.

For discussion purposes, the execution of the instructions by the processing resource 1204 has been described with reference to various components introduced earlier with reference to description of FIGS. 2 and 3.

On execution by the processing resource 1204, the controller 208 may actuate the servo motor of the pick-up roller 202 to pick the first print medium 402. Further, the controller 208 may also synchronize the motion of the pick-up roller 202 and the transfer roller 204 as the first print medium moves along the travel path. In one example, the controller may detect a leading edge of the first print medium and generate a detection signal that may be used by the controller to synchronize the motion of the first print medium and the second print medium. Further, the controller 208 may determine when the first print medium arrived at the homing position. In one example, the controller 208 may determine when the first print medium arrived at the homing position based on the detection signal and motion of the transfer roller 204 as explained before. Further, the controller 208 may actuate the servo motor of the pick-up roller 202 to pick the second print medium 408 while at the same time, actuates the servo motor of the transfer roller 204 to feed the first print medium 402 to the print area. Finally, the controller 208 may adjust the gap between the leading edge of the second print medium 408 and the trailing edge of the first print medium 402 by regulating a rotational speed of the pick-up roller based on an instantaneous rotational speed of the transfer roller.

Although aspects for methods and systems for adjusting the gap between consecutive print medium have been described in a language specific to structural features and/or methods, the present subject matter is not necessarily limited to the specific features or methods described. Rather, the specific features and methods are disclosed as examples for adjusting the gap.

1. A method comprising:
picking a first print medium from an input tray by a pick-up roller and moving the first print medium along a travel path by the pick-up roller and a transfer roller;
detecting a position of the first print medium with respect to a homing position on the travel path;
picking a second print medium from the input tray by the pick-up roller in response to detection of the position of the first print medium being the homing position; and
adjusting a gap between a leading edge of the second print medium and a trailing edge of the first print medium by regulating a rotational speed of the pick-up roller based on a rotational speed of the transfer roller.

2. The method as claimed in claim 1 further comprising:
detecting a leading edge of the first print medium using a sensor and generating a detection signal based on detection of the leading edge of the first print medium; and
synchronizing rotational speeds of the pick-up roller and the transfer roller in response to the detection signal.

3. The method as claimed in claim 1 further comprising allowing independent motions of the pick-up roller and the transfer roller upon detection of the position of the first print medium being the homing position.

4. The method as claimed in claim 1, wherein the rotational speed of the transfer roller is based on an instruction to print content on the first print medium.

5. The method as claimed in claim 4, wherein the instruction includes markings to be formed, a size of print media, and margins for the first print medium.

6. An imaging device comprising:
a pick-up roller to pick print media from an input tray;
a transfer roller to receive the picked print media from the pick-up roller and move the print media along a travel path;
a sensor positioned along the travel path to detect a leading edge of the print media and generate a detection signal upon detection of the leading edge; and
for a first print medium and a second print medium of the picked print media, a controller comprising:
a determination engine to determine arrival of the first print medium at a homing position based on a measurement of a degree of rotation of the transfer roller, wherein the measurement is triggered by the detection signal; and
an adjustment engine to adjust a gap between a leading edge of the second print medium and a trailing edge of the first print medium by regulating a rotational speed of the pick-up roller based on the rotational speed of the transfer roller.

7. The imaging device as claimed in claim 6 further comprising an input tray to store the print media and a biasing member to press a stack of print media against the pick-up roller.

8. The imaging device as claimed in claim 6, wherein the controller further comprises a receiving engine to receive the detection signal and an instruction from a user device to perform a printing operation.

9. The imaging device as claimed in claim 8, wherein the instruction includes content to be printed, type of the print media, and margins for the first print medium.

10. The imaging device as claimed in claim 6 further comprises variable-speed motors of each of the pick-up roller and the transfer roller.

11. The imaging device as claimed in claim 6, wherein the transfer roller is placed downstream with respect to the pick-up roller along the travel path.

12. The imaging device as claimed in claim 6, wherein the sensor is placed proximate to the pick-up roller.

13. The imaging device as claimed in claim 6, wherein the sensor is placed proximate to the transfer roller.

14. A non-transitory computer-readable medium comprising computer-readable instructions for adjusting a gap between a leading edge of a second print medium and a trailing edge of a first print medium, when executed by a processing resource, cause the processing resource to:
pick, by a pick-up roller, the first print medium from an input tray and feed the first print medium to a transfer roller along a travel path;
detect, by a sensor, the leading edge of the first print medium and generate a detection signal;
synchronize motions of the pick-up roller and the transfer roller as the first print medium moves along the travel path;
detect arrival of the first print medium at a homing position using the detection signal and a motion of the transfer roller to allow independent motions of the pick-up roller and the transfer roller; and
pick the second print medium by the pick-up roller while feeding the first print medium to a print area by the transfer roller; and
adjust a gap between the leading edge of the second print medium and the trailing edge of the first print medium by regulating a rotational speed of the pick-up roller based on an instantaneous rotational speed of the transfer roller.

15. The non-transitory computer-readable medium as claimed in claim 14, wherein the processing resource receives an instruction to print content on the first print medium, and wherein the instruction includes markings to be formed, a size of print media, and margins for the first print medium.
